(19) United States
(12) Patent Application Publication
(10) Pub. No.: US 2014/0149245 A1
(43) Pub. Date: May 29, 2014

(54) Method and System For Providing A Social Trade Network

(71) Applicants: Ron Topol, Nes Tsiona (IL); Nirit Topol, Nes Tsiona (IL)

(72) Inventors: Ron Topol, Nes Tsiona (IL); Nirit Topol, Nes Tsiona (IL)

(21) Appl. No.: 14/131,271

(22) PCT Filed: Jul. 5, 2012
(86) PCT No.: PCT/IL2012/000273

§ 371 Date: Jan. 7, 2014

Related U.S. Application Data
(60) Provisional application No. 61/505,550, filed on Jul. 8, 2011.

(51) Int. Cl. G06Q 30/08; G06Q 50/00

(52) U.S. Cl. CPC G06Q 30/08; G06Q 50/01
USPC 705/26.3

(57) ABSTRACT

The aim of this system is to enable a negotiation between groups of buyers and variety of sellers. The negotiation between the buyers and sellers is possible through an automatic system of matching between buyers' requests and sellers' offers. The buyers' requests are united by the system in terms of quantity and quality of the requests. Then, the negotiation between the buyers and sellers is conducted between the united requests of the buyers and the coupons/offers which the sellers offer to that group until a transaction is made and both sides agree on the terms of the transaction.

### FIELD OF THE INVENTION

The present invention relates to the field of electronic commerce auction system and social networks. More particularly, the present invention relates to a method and system for managing an online business transaction in efficient manner, allowing buyers to have a certain discount and seller to give a possible discount by matching between joined “buying requests” of the buyers and offers of the sellers for implementation of selling transactions.

### BACKGROUND OF THE INVENTION

Nowadays many computer users are connected to the Internet and conduct their shopping activities electronically. For that activity, there are several sites that offer different kinds of online buying groups and discount coupons. Each site does it in a different way, for example:
http://www.oltiby.com—a site of reverse online auction—Buyers choose the product they are interested to buy and sellers suggest selling this product to buyers. The cheapest offer is chosen. The buyer is individual and doesn't join a buying group. In such a site the price of the product is supposed to be cheaper because the sellers compete with each other in order to win the individual's request.
Also, if the buyer's request is answered by a seller's offer—then, the buyer pays to the site service reverse auction fees which are calculated as a percentage from the final price. However, such reverse online auction lack of the ability to allow buyers to be united as a group and therefore lack of the ability to receive a group discount. Moreover, such reverse online auction lack the ability of the buyer to impress how much he is earnest to buy the product and lack the ability of the seller to evaluate the buyers' earnest/seriousness to buy the product.
http://www.groupon.com—Buying groups coupon's sites—Buyers receive a daily mail that details the coupons they can buy or look for the daily offer of coupons in the company's website. The buyer can't choose which offer he will get and needs to check his mail/the web site each day in order to track the offer that is suitable for him. Also, the seller needs to be accepted to the daily publication of the coupon's company who operates the site, in order to publish his offer. Usually the seller needs to offer at least 50% in order to be accepted. However such buying groups lack of the ability to allow buyers to submit a request according to their needs, at the time and terms they would like to buy this product and to allow sellers to know in advance the buyer's needs and level of commitment.

It is an object of the present invention to provide a social trade network for allowing individuals buyers to participate in the process of creating “buying request” suitable for their individual needs of buying terms for a product.

It is a further object of the present invention to provide auction system which gives the buyer to impress his earnest to buy the product in the “buying request” This component enables to the system measure the quality of the buyers.

It is a further object of the present invention to provide a system for aggregating and unite similar “buying requests” in their terms of buying and earnestness to buy into one joined “reverse coupon” which represents the buying power of homogeneous group of buyers in terms of quantity and quality. The “reverse coupon” enables the sellers to receive important information on the buyers' intentions and seriousness and to apply to the buyers as a group with a suitable offer. It is a further object of the present invention to enable sellers to create a “response coupon” that relates to a “reverse coupon”.

It is a further object of the present invention to provide an auction system for automatically matching between “reverse coupons” and “response coupons” and to notify the buyers and sellers when there is a match to their request or offer.

It is a further object of the present invention to provide an auction system for negotiation on the terms of buying, earnests of buying, and quantity of buyers: between the current buyers who update their “buying request”, new buyers who create new “buying requests” and sellers who update their “response coupons”.

It is yet another object of the present invention to generate a kind of bid between all the “response coupons” that suit the “reverse coupon”. The sellers compete with each other on the best offer for the buyer's to buy, and the buyers need to buy at least one preferred “response coupon”.

Other objects and advantages of the invention will become apparent as the description proceeds.

### SUMMARY OF THE INVENTION

The aim of this system is to enable a negotiation between groups of buyers and variety of sellers. The negotiation between the buyers and sellers is possible through an automatic system of matching between buyers' requests and sellers' offers. The buyers' requests are united by the system in terms of quantity and quality of the requests. Then, the negotiation between the buyers and sellers is conducted between the united requests of the buyers and the coupons/offers which the sellers offer to that group until a transaction is made and both sides agree on the terms of the transaction.

The present invention relates to a method for providing a social trade network capable of conducting an online auction for items, which comprises:
a) receiving, at a website associated with a computer system, one or more “buying request” for buying items from one or more buyers registered to participate in said online auction, wherein each “buying request” includes the following properties: the maximum price of the item, “earnest fee” level/amount, wherein the amount of said “earnest fee” defines the price the buyer will need to pay in case he will receive at least one matched “response coupons”, but won't buy any of them until the “buying deadline” of the request will end—this component reflects the level of commitment of this buyer;
b) aggregating all the similar “buying requests” in terms of buying and “earnest fee” into one aggregated “reverse coupon”. Each “reverse coupon” includes the amount of requests and the “earnest fund” summarizes the “earnest fees” of all the “buying requests” of a product with the same buying terms and earnest fees. This component enables the sellers to apply to the buyers as a united homogeny committed group of buyers;
c) receiving, at said website, one or more “response coupon” for selling one or more items from one or more of said sellers with respect to said provided properties, wherein each “response coupon” includes the following properties: the price of the item and may include the “minimum amount of requests” needed to activate the coupon and the “minimum earnest fund” needed to activate the coupon;
d) matching the properties of said received “reverse coupon” to the properties of said received “response coupon” and notifying the relevant buyers and sellers about their matched coupons;
e) setting a “buying deadline” for each “buying request” which received matched “response coupon”. If there is no matched “response coupon”, then there is no “buying deadline” and the buyer can dismiss his participation in the “buying request” any time without payment. The meaning of the “buying deadline” is: for the buyer, he needs to buy at least one “response coupon” until that date or he will be charged for his “earnest fee”, and for the seller, he is committed to allow the buyer to buy that “response coupon” without changing it for the worth or dismissing it until the end of the “buying deadline”; and
f) charging the “earnest fee” from the buyers in case their “buying deadline” was over and they didn't buy any matched “response coupon”.

According to an embodiment of the invention, each “buying request” includes at least the following properties: the maximum price of the item, an “earnest fee” level/amount, payment details and other optional term(s) for buying said item.

According to an embodiment of the invention, the buyers must provide the level/amount of the “earnest fee” they are willing to pay in case there will be a matched “response coupon” and they won't buy any “response coupon” until the end of their “buying deadline”, wherein each buyer needs to provide his contact details and payment details when submitting his “buying request”, for enabling the system to charge the buyer for his “earnest fee” in case he won't buy any matched “response coupon” until the end of his “buying deadline”.

According to an embodiment of the invention, each “response coupon” includes the price of a specific item and may include the following properties: minimum “earnest fund” amount, minimum number of buyers needed and other optional term(s) for selling said item, wherein the “response coupon” applies to specific groups of committed buyers shown in the “reverse coupons”.

According to an embodiment of the invention, all buyers are aggregated in a committed group of potential buyers, wherein the buyers submit their “buying request” individually and then their requests are aggregated by the system into one “reverse coupon” with the same terms of transaction (including “earnest fee” and price requested), wherein the buyers can receive matched “response coupons” as part of a united committed group of buyers, and wherein the system is updated all the time according to the current status of all the buying requests and response coupons existed in the site.

According to an embodiment of the invention, the system matches between the aggregated “reverse coupons” and the sellers' “response coupons” and sending the relevant buyers their matched “response coupons”, wherein the matching process includes the parameters of price requested for a specific product and “earnest fee/fund” needed.

According to an embodiment of the invention, the system creates a “buying deadline” for each buyer when he receives the first matched “response coupon” for a specific “buying request”, wherein if the buyer won't buy any matched “response coupon” until the end of his “buying deadline”, then the system will charge the “earnest fee” he was committed to in his “buying request”.

According to an embodiment of the invention, the method further comprises providing the buyer with plurality of matched “response coupons” if exists in the system, and allowing said buyer to buy at least one “response coupon” among said plurality of “response coupons” until the end of his “buying deadline”, wherein the sellers can submit competing matched “response coupons” and there is a bid on the aggregated “reverse coupon” which contains a group of committed buyers, and therefore, creating an ongoing process of competition between said sellers.

According to an embodiment of the invention, when the first matched “response coupon” will be sent to all the buyers in the same “reverse coupon”, they will also receive a same “buying deadline”, wherein when a new “buying request” will be aggregated to a matched “reverse coupon” his “buying deadline” will start from the date he joined, and therefore, the number of buyers in the “reverse coupon” can increase because new buyers are joined by the system to that coupon or decrease because different buyers can have different “buying deadlines” and can buy the “response coupon” in different dates until the end of their “buying deadline”.

According to an embodiment of the invention, the plurality of “response coupons” are provided to the buyer via any suitable notification method, such as email, SMS, the buyer's profile webpage, or any combination thereof.

According to an embodiment of the invention, the method further comprises enabling the seller to automatically see all similar “reverse coupons” that have the same parameters, aggregated and related to the specific product the seller would like to sell.

According to an embodiment of the invention, the “earnest fee” is differential and each buyer can define his “earnest fee” individually, wherein higher level/amount of earnest fee represents more serious buyers, which allows sellers to provide much better “response coupons” to that buyers, and lower level/amount of earnest fee represents less serious buyers, which allows sellers to know in advance that these potential buyers are less committed to buy the matched “response coupon”.

According to an embodiment of the invention, the method provides a platform for open and dynamic negotiation between buyers and sellers, where buyers and sellers can update their coupons. For example: The seller can encourage more buyers to create a “buying request” by submitting a “response coupon” with number of buyers needed in order to activate his coupon that will be higher than the number of “buying request” which were already aggregated to the relevant “reverse coupon”; The seller can see the price requested and “earnest fee” commitment of the buyers shown in the “reverse coupon” and submit a “response coupon” close but not matched to the “reverse coupon”; The buyers can submit a “buying request” close but not the same as the price of the seller. All the information of the reverse and response coupons is open to both buyers and sellers. Buyers and sellers can change their “buying requests” and “response coupons” simultaneously until they reach an agreement and the transaction is made.

According to an embodiment of the invention, the method further comprises a) allowing a buyer to dismiss his “buying request” any time and only to pay the “earnest fee” in case there is already matched “response coupon”, wherein if there is no matched “response coupon” or if the buyer already bought a “response coupon”, then the buyer isn't committed to pay his “earnest fee” when he dismiss his “buying request”; and b) allowing seller to dismiss his “response coupon” and only to allow the buyers who received his matched “response coupon” to buy it until the end of their “buying deadline”.

According to an embodiment of the invention, the method further comprises charging the buyer's “earnest fee” in case he didn't buy any matched “response coupon” until the end of his “buying deadline”.

According to an embodiment of the present invention, buyers related to the same “reverse coupon” will have to buy the same “response coupon” chosen by the system for being with the lowest price for example. Otherwise, the “earnest fees” of the buyers who didn't buy the chosen “response coupon” will be charged and transferred to the seller who submitted this coupon.

According to one embodiment of the present invention the seller can choose to submit his “response coupon” personally and secretly. Meaning the seller can request to send his coupon and to allow to buy his coupon only to the buyers who submitted a matched “buying request” aggregated in the “reverse coupon”. This tool can help the sellers to keep their high price of selling product in the market, and to give a certain discount to a limited amount of buyers without the need to publish their price in publicity.

The buyers are committed to buy from one of the sellers that will submit a matched “response coupon” until the end of their “buying deadline”, but they aren't committed to buy from a specific seller. It is an open bid between the sellers on the buyers' “reverse coupon”.

Each buyer related to the “reverse coupon” can choose individually the “response coupon” he would like to buy from. The group of buyers united in the “reverse coupon” isn't committed to choose the same “response coupon” for the whole group to buy from.

Another embodiment of the present invention is that the buyer can determine the quantity of the same product he is interested in, in his “buying request”. Then, the system will aggregate the number of “buying requests” including the number of products/services requested. Each “buying request” will include only one “earnest fee”, but if the buyer will receive a matched “response coupon” but won't buy the exact amount that he requested until the end of his “buying deadline”, then the “earnest fee” will be charged by the system even if he bought only sum of the amount.

Another embodiment of the present invention is that the buyer can determine several products of the same category in his “buying request”. Then, the “buying deadline” will be set for both products when the first matched “response coupon” will be received for one of these products. The “earnest fee” will be charged only once if the buyer won't buy any of these products although he received matched “response coupons” for at least one of them and his “buying deadline” was over.

The present invention further relates to a computer system for conducting an online auction for items, which comprises: a) a set of related documents and associated files; and b) a server for serving up the set of related documents and associated files to a plurality of terminal devices to provide buyers and sellers with capability to participate in said online auction, wherein said server being programmed with application software to perform the online auction.

According to an embodiment of present invention, the application software involves the following tasks:
a) receiving one or more “buying requests” for buying items from one or more buyers registered to participate in said online auction, wherein each “buying request” includes the following properties the kind of product, the maximum price of the item, “earnest fee” level/amount, payment details and one or more terms for buying said item;
b) providing the properties of selected “reverse coupons” for one or more sellers registered to participate in said online auction for allowing each of said sellers to publish “response coupons” wherein each “response coupon” includes the following properties the kind of product, the price of the item, minimum “earnest fund” amount needed, minimum numbers of buyers needed and one or more terms for selling said item;
c) aggregating all the similar “buying requests” of the different buyers into one “reverse coupon” with specific quality and quantity. This way the sellers will be able to see the quantity and quality of the buyers in an aggregated way. The quantity is measured by the number of buying requests who were joined by the system to the same “reverse coupon” and the quality is measured by the “earnest fee” the buyers are committed to. The “earnest fund” is measured by the “earnest fee” X the amount of “buying requests”.
d) matching the properties of the “reverse coupons” to the properties of said received “response coupons”;
e) creating the “buying deadlines” of the buyers related to the “reverse coupon” after a first matched “response coupon” is found;
f) allowing the buyers to receive a plurality of matched “response coupons” from different sellers related to the same “reverse coupon”; and
g) performing a transaction whenever the buyer choose to buy a “response coupon” or charging the buyer's “earnest fee” in case he didn't buy any matched “response coupon” until the end of his “buying deadline”.

The system is dynamic and based on ongoing flow of information between buyers and sellers within an open social trade network, which is based on the following main components:
1) The component of “reverse coupon” which reflects joined “buying requests” of all the buyers who requested the same buying terms of price for a product and “earnest fee”. The buyers submit their “buying request” individually and the system aggregates the same buying terms into one group of committed buyers shown to sellers and other buyers as “reverse coupon”. Simultaneously, the sellers can submit their “response coupon” according to the “reverse coupons”, or as selling proposal shown in the site. The “reverse coupon” and “response coupons” serve as an intermediary tool that enables to connect between groups of united buyers and sellers by matching between them for negotiating in efficient, fair and convenient way for both sides.
2) The component of “earnest fund” in the “reverse coupon” reflects a fund which summarizes all the “earnest fees” in all of the “buying requests”. The buyers determine when they submit their personal “buying request” also their “earnest fee”—the fee they are willing to pay in case they will receive a matched “response coupon”, but won't buy it until the end of their “buying deadline”.
   The “reverse coupon's” “earnest fund” and the “reverse coupon's” request amount joined together, enables the seller to receive a kind of “safety net” measuring the number of committed buyers and their level of commitment. This tool can help the sellers to better evaluate their risk management of stock, price offered, etc. and by doing so, to be able to give possible discount to the committed group of buyers.
3) The component of “buying deadline” of the “buying request” enables to create a kind of bid between the sellers on the “reverse coupon”. The “buying deadline” starts when the first matched “response coupon” is submitted. When the “buying deadline” is over, the buyer the “earnest fee” is charged only if the buyer didn't buy any matched “response coupon”. Therefore, the “reverse coupon” may include buyers with overlapping “buying deadlines”.

### BRIEF DESCRIPTION OF THE DRAWINGS

In the drawings:

FIG. 1 schematically illustrates a computer system for conducting an online auction for items, according to an embodiment of the present invention;

FIG. 2 schematically illustrates an example for buyers' and sellers' screen when they enter to the system, viewing the reverse and response coupons in the system. according to an embodiment of the present invention;

FIG. 3 schematically illustrates an example for buyer's screen for submitting a “buying request”, according to an embodiment of the present invention;

FIG. 4 schematically illustrates the buyer's screen for viewing in real time the state of his “buying request”, according to an embodiment of the present invention.

FIG. 5 schematically illustrates an example for the seller's screen for submitting a “response coupon”, according to an embodiment of the present invention;

FIG. 6 schematically illustrates the seller's screen for viewing in real time the state of his “buying request”, according to an embodiment of the present invention

### DETAILED DESCRIPTION OF PREFERRED EMBODIMENTS

The Figures and the following description relate to preferred embodiments of the present invention by way of illustration only. It should be noted that from the following discussion, alternative embodiments of the configurations and methods disclosed herein will be readily recognized as viable alternatives that may be employed without departing from the principles of the claimed invention.

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the system and methods illustrated herein may be employed without departing from the principles of the invention described herein.

Unless otherwise indicated, the functions described herein may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

Similarly, while certain examples may refer to a Personal Computer (PC) system or data device, other computer or electronic systems can be used as well, such as, without limitation, an interactive television, a network-enabled personal digital assistant (PDA), a smart phone (e.g., with an operating system and on which a user can install applications) and so on.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

### DEFINITIONS

The term “Buyer” refers herein to an entity which is either an individual person or a company that creates a “buying request” to buy a product or service in the site or search for a product/service in our site. If there is a “response coupon” active in the system, then the buyer can buy this coupon.

The term “Seller” refers herein to an entity which is either an individual person or company that publishes a “response coupon” to sell a product/service in our site which includes the price offered for the product.

“Buying request”—Each buyer can create a “buying request” that refers herein to a buyer that provides information to the auction system which reflects the buyer's intentions to buy an item (a product or a service) via the auction system of the present invention. The parameters of a “buying request” are: inserting the product requested; the maximum price for that product and the “earnest fee” level/amount including payment details.

The personal details of the buyers including their payment details will be saved confidentially by the system. The system will charge the “earnest fee” if needed and therefore the payment details are necessary at the stage of submitting the “buying request”. Another implementation of this invention is that the buyer will be able to add more personal parameters like the sellers he agrees to buy from, group of products etc.

The term “Earnest fee” refers herein to a level/amount of price that the buyer is committed to as part of creating to a “buying request” for buying a product (or an item) via the system of the present invention. In this context, the term level refers to a set of predefined earnest amounts, wherein each amount represents different level. The “earnest fee” enables to measure the quality of seriousness in buying the product.

The “earnest fee” will be charged by the system only if the buyer will receive a matched “response coupon” and the buyer won't buy any of the matched “response coupons” he received until the end of his “buying deadline”. If there is no matched “response coupon” then the buyer isn't committed and he can dismiss his participation in the “reverse coupon” without any payment, any time.

The term “reverse coupon” refers herein to aggregated “buying request” which have the same buying terms of price requested for a specific product and level/amount of “earnest fee”. The system aggregates all the similar “buying requests” into one aggregated homogeny group of committed buyers. The system enables sellers and other buyers to watch the aggregated “reverse coupons” and by that encourages sellers to offer a matched or discounted “response coupons” applied to homogeny committed group of buyers. Even after a “response coupon” is published new buyers can submit “buying requests” that will be joined by the system to the “reverse coupon” and will enlarge the size of the group and its buying power.
The quantity of the group is measured by the “reverse coupon's” requests amount. This component refers herein to the number of “buying requests” aggregated together in specific “reverse coupon”. The “reverse coupon's” request amount reflects the quantity aspect of the “reverse coupon” meaning the number of same “buying requests” for a product.
This component enables the sellers to predict how many transactions they should expect to. The number of buyers can also decrease since different buyers will have different “buying deadlines” for example: a) If a “buying request” is aggregated to a “reverse coupon” after there is already a matched “response coupon” he will receive different “buying deadline” than the existed group who was joined before there was a matched “response coupon”. b) According to an embodiment of the present invention each buyer can choose several products from the same category and therefore he will receive “buying deadline” which relates to the first matched “response coupon” he will receive for one of these products.

The term “reverse coupon's” “earnest fund” refers herein to a fund of shared “earnest fees” aggregated together by the system in the “reverse coupon”. The “reverse coupon's” “earnest fund” reflects the quality aspect of the “reverse coupon”. Meaning how much the potential buyers are serious in their buying intentions.

This component enables the sellers to predict how many transactions they should expect to. The sellers often face the problem of evaluating the seriousness of the buyer, especially in the internet commerce and the “earnest fund” summarizes and measures the seriousness of the potential buyers.

Since the system creates all kinds of “reverse coupons” it can happen that the same “response coupon” will be matched to several “reverse coupons”. For example, if one “reverse coupon” contains 100 “buying requests” of 10$ “earnest fee” per request, then the “earnest fund” will be 1000$ if and other “reverse coupon” contains 10 “buying requests” of 100$ “earnest fee” per request, then the “earnest fund” will be also 1000$. Therefore, the two “reverse coupons” can be matched to a “response coupon” of a seller who defines 1000$ “earnest fund” for buying a specific product at a specific price.

According to an embodiment of the present invention the buyers in the same “reverse coupon” will have to buy the same “response coupon” chosen by the system for being with the lowest price for example. Otherwise, the “earnest fees” of the buyers who didn't buy the chosen “response coupon” will be charged and transferred to the seller who submitted this coupon.

“Response coupon”—the term refers herein to a seller that provides information to the auction system which represents the seller's offer to sell an item (a product or a service) via the auction system of the present invention. The parameters of a “response coupon” are: Price for specific product, and may contain parameters of the “minimum earnest fund” amount and the “minimum requests amount” needed for that “response coupon” to be active. Another implementation of this invention is that the seller will be able to add more parameters like the maximum amount of products for sale, the “expired date” of his coupon, etc. The “response coupon” applies to a groups of homogeny united committed buyers for a specific product and this is the main difference between it and a regular offer that applies to a non-committed group of buyers or an individual committed buyer.

The term “matched coupons” refers herein to a “reverse coupon” and “response coupon” which were found suitable to each other, meaning: “reverse coupon's” requested price is equal to/higher than the requested price of the “response coupon”. The date which the “response coupon” was matched is important since then the “buying deadline” is created for all the buyers who are related to the matched “reverse coupon”. For the buyer, he needs to buy at least one offer until the end of the “buying deadline” or his “earnest fee” will be charged and for the seller, he is committed to sell his coupon to the buyers who received his offer until the end of their “buying deadlines”. Each “response coupon” can be matched to several “reverse coupons” according to the buying terms of these coupons. Also, each “reverse coupon” can be matched to several “response coupons” according to the buying terms of these coupons.

“Minimum request amount”—The seller may inserts “minimum request amount” in order to activate his “response coupon”. Meaning the coupon will be active only if the amount of all the “buying requests” joined in the “reverse coupon” will be equal or higher than the “minimum request amount” specified in the “response coupon”.

“Minimum earnest fund”—The seller may insert “minimum earnest fund” in order to activate the “response coupon”. Meaning the coupon will be active only if the amount of all the “earnest fees” joined in the “reverse coupon” will be equal or higher than the “minimum earnest fund” specified in the “response coupon”.

“Social Trade Network”—the negotiation between Buyers' “reverse coupons” and sellers' “response coupons” is part of a live and dynamic social trade network. The network allows each individual buyer to create his “buying request” to buy a product in certain terms and to be treated as part of united group of buyers.

Also, the system enables the sellers to submit their “response coupon” in certain buying terms and to apply to united and committed group of buyers. Both sides—buyers and sellers—have the opportunity to influence on each other: on the other side's price requested, size of the group needed and “earnest fund” needed by updating their offers and requests, until the transaction is made.

The term “Dismiss buying request” refers herein to the buyer's option to dismiss his “buying request” at any time. If the buyer already received a matched “response coupon”, he will be charged for his “earnest fee” (if he wasn't already charged). If he didn't receive any matched “response coupon”, then he won't be charged.

The term “dismiss response coupon” refers herein to the seller option to dismiss his “response coupon” at any time. If the seller's “response coupon” was already matched to a suitable “reverse coupon”, then he is obliged to allow that buyers to buy his “response coupon” until the end of their “buying deadlines”. And if no matched “reverse coupon” was found, then the seller can dismiss his “response coupon” without any further commitment. The system updates all the time the aggregated “reverse coupons” and matched “response coupons” according to the buyers' and sellers' changes.

The term “Buying deadline” refers herein to a date that each “buying request” receives when a first matched “response coupon” is found. Afterwards, in the second matched “response coupon” and so on, the same “buying deadline” of the request will remain, and the buyer will have to buy at least one “response coupon” from the list of matched “response coupons”. If the buyer won't buy any “response coupon”, the earnest fee will be charged from him.

Buyers can create freely all the time “buying requests”. When “buying request” is aggregated to an existing “reverse coupon”, there are two options for the creation of his “buying deadline”:
1) If there is no matched “response coupon”, then when the first matched “response coupon” will be submitted, the entire group will receive the same “buying deadline”. It can happen that no matched “response coupon” will be submitted, and therefore “buying deadline” won't be created for that buyers.
2) If there are already matched “response coupons”, then new “buying deadline” will be created for this buyer that can be different from the existed group—depending on the time each “buying request” was aggregated to the “reverse coupon” after creating his “buying request”. The buyer can also choose to buy an existing “response coupon” without the need to create a “buying request” of his own. Therefore, the same “reverse coupon” can refer to different buyers with different overlapping “buying deadlines”.

Another implementation of the present invention is that the seller can add the parameter “expired date” for his “response coupon”. After the “expired date” will be over the “response coupon” will be dismissed from the system and buyers won't be able to buy this coupon. Therefore the “expired date” can be over even before the “buying deadlines” of all the buyers related to the “reverse coupon” are over.

Another implementation is that the seller can determine in his “response coupon” the amount of the products he is willing to sell; therefore the amount can be sold out even before the “buying deadlines” of all the buyers related to the “reverse coupon” are over.

Therefore, it can happen that a buyer will receive a matched “response coupon” and a “buying deadline” will be created, but at the end of that date the “response coupon” won't be valid, since the “response coupon” was published with a limited amount of products which was sold out or “expired date” that was over. The system will charge the buyer for the “earnest fee” only if at the end of the “buying deadline”, there will still remain at least one active matched “response coupon”.

Also, another implementation of that system is that the “earnest payment” can relate to a category of several products. This means that a buyer can create a “buying request” for the product A with the price requested B and amount of “earnest fee” C and also to create a “buying request” for the product D with the price requested E and amount of earnest fee C. If the products A and D relate to the same group of products, then the amount C will be charged (according to the rules of the system) only once for both “buying requests” and not twice because the products A and D are in the same group.

The “buying deadline” will be counted from the first matched “response coupon” submitted for any of the products A or D, meaning it will be one “buying deadline” for both “buying requests” of the two products. This implementation allows more independence and freedom for each individual buyer to reflect his personal preferences. Moreover, it causes to enlargement of the size of the groups in the “reverse coupons” since the same buyer is counted in two different “reverse coupons”.

Another implementation of that system is that the system charges the “earnest fee” when there is a first matched “response coupon”. In this case the system will need to insure that matched “response coupons” will be remained until the end of the “buying deadlines”. Also, in this case if the buyer will buy a “response coupon”, then the amount of the “earnest fee” that was charged from him will be deducted from the price offered in his preferred “response coupon”.

From the buyer's point of view—The present invention enables potential buyers to request and commit to buy a product or a service they are interested in. As a result of that, the buyers may get a better deal for the products or services they are interested in. The present invention enables individual buyers to reflect their preferred request's terms and to be treated as a group of buyers. Moreover, it may avoid from the buyers the need to be involved with marketing promotion of products that are not relevant for them.

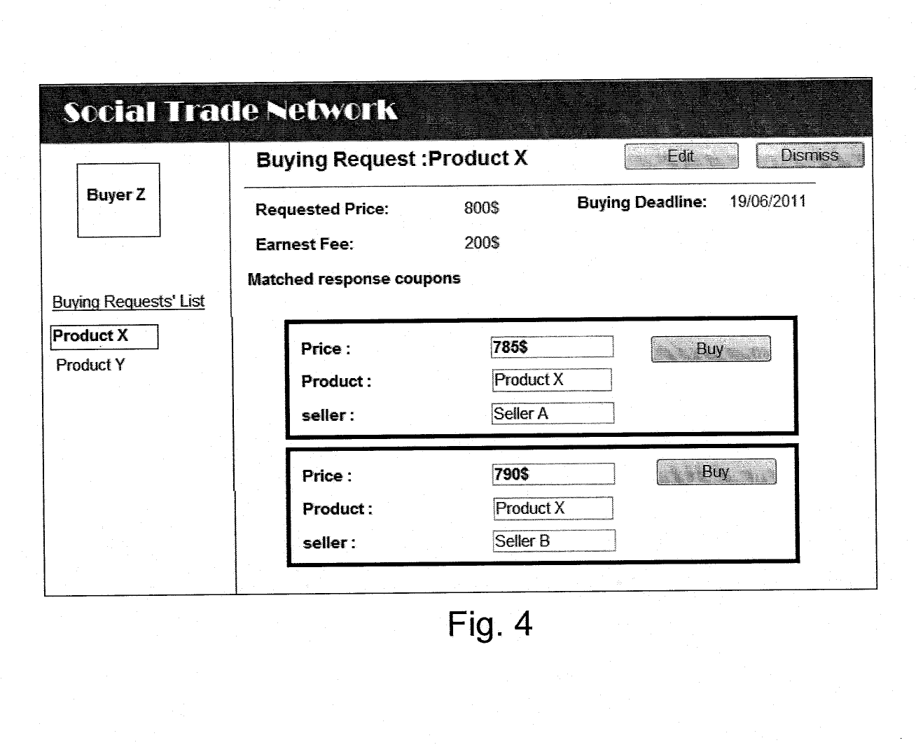

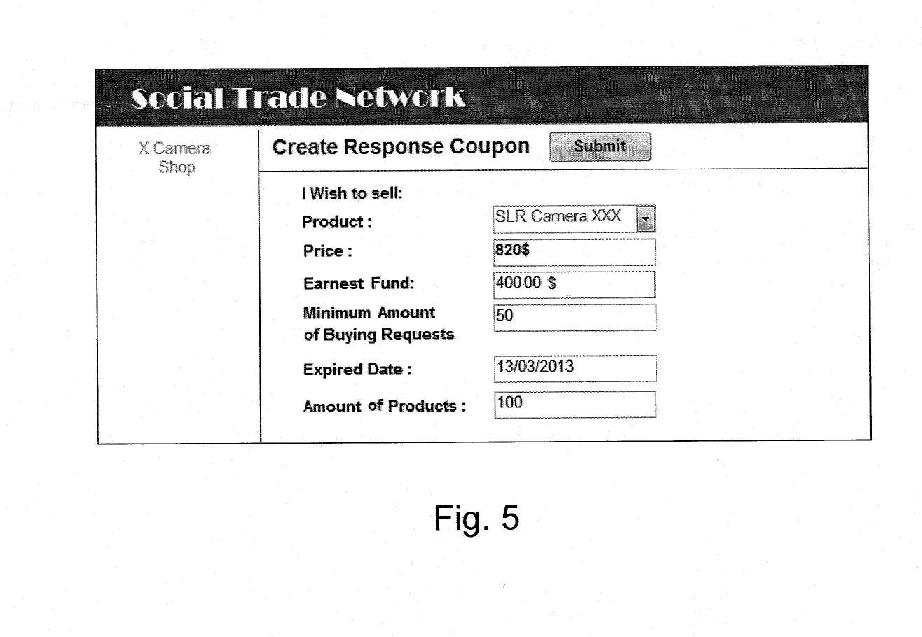

From the seller's point of view—The present invention enables each seller to see the quantity of the buyers and quality of their seriousness to buy the product the seller is interested to sell. As a result of that, the seller may maximize his profits by considering this information, before he publishes the actual “response coupon”. Moreover, it allows a seller to improve the control on supply flow and income by previewing the amount of buyers in more accurate way. Sellers can create a “response coupon” without the need to receive an approval by the system on the terms of transaction of their coupon. The seller webpage is described in further details hereinafter with respect to FIGS. 4 and 5.

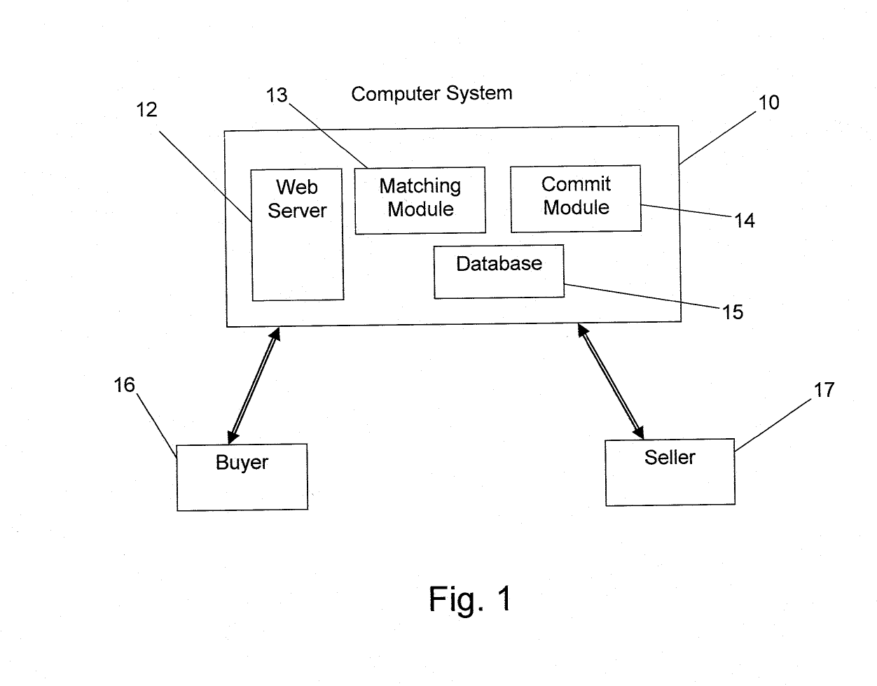

Referring now to FIG. 1, a computer-buyer social trade network system 10 for matching between sellers' “response coupons” to sell products or service items and buyers' “buying requests” wishing to purchase product or service items is schematically illustrated in accordance to an embodiment of the present invention. The computer system 10 comprises a web server 12, a matching module 13, a commitment module 14 and a database 15. The computer system 10 is configured to communicate with user terminals, such as a buyer terminal 16 and a seller terminal 17, over a data network such as the Internet. The user terminal can be a personal Computer (PC), a cellular telephone, a smart-phone or any other computer device with communication capabilities with the data network.

The computer system 10 presents a first interface for access by buyers (via their buyer terminal 16) in communicating willingness to purchase any desirable item, and a second interface for access by sellers (via their seller terminal 17) in communicating willingness to offer items for sell. The first interface includes an “earnest fee” and price requested for a specific product.

The database 15 is associated with the server 12 and the corresponding modules 13 and 14 (i.e., the auction engine) for storing the identity of buyers who have communicated willingness to purchase items, and for storing data indicative of the “earnest fee” and requested maximum price communicated by each buyer.

The second interface has a seller “response coupon” field through which each seller provides the price he is willing to offer and the “earnest fee” and minimum amount of “buying requests” needed in the “reverse coupon” in order to receive this “response coupon” as a matched “response coupon” ready to buy.

The matching module 13 is having a mechanism for matching between the “reverse coupons” and the “response coupons” in response to a pre-defined matching criterion and for identifying buyers and sellers that has met the pre-defined conditions. The matching module 13 communicates with the computer system 10 to generate a matching record for at least a portion of the identified buyers and sellers. Each matching record includes the identity of the buyers and sellers, the item properties on which the buyers and the sellers negotiated and data indicative of the “earnest fund” and price of the product offered by the selected seller.

Each seller/buyer can improve his “response coupon”/“buying request” for the other side's benefit and by that to rematch to more “buying request”/“response coupons”. The buyer/seller can't change his “response coupon”/“buying request” for the worth of the other side. In that case, he needs to dismiss his “buying request”/“response coupon” and to submit a new one with new parameters and conditions for the “buying request”/“response coupon”.

The system's server collects all the reverse and response coupons and creates matching between them. Each time there is a first match for the “reverse coupon”, a “buying deadline” for the “buying requests” which were aggregated to this “reverse coupon” is set. During this period, the same sellers whose “response coupon” was matched to this “reverse coupon” can improve their “response coupon” and also other sellers can submit new “response coupons” which matches to that “reverse coupon”.

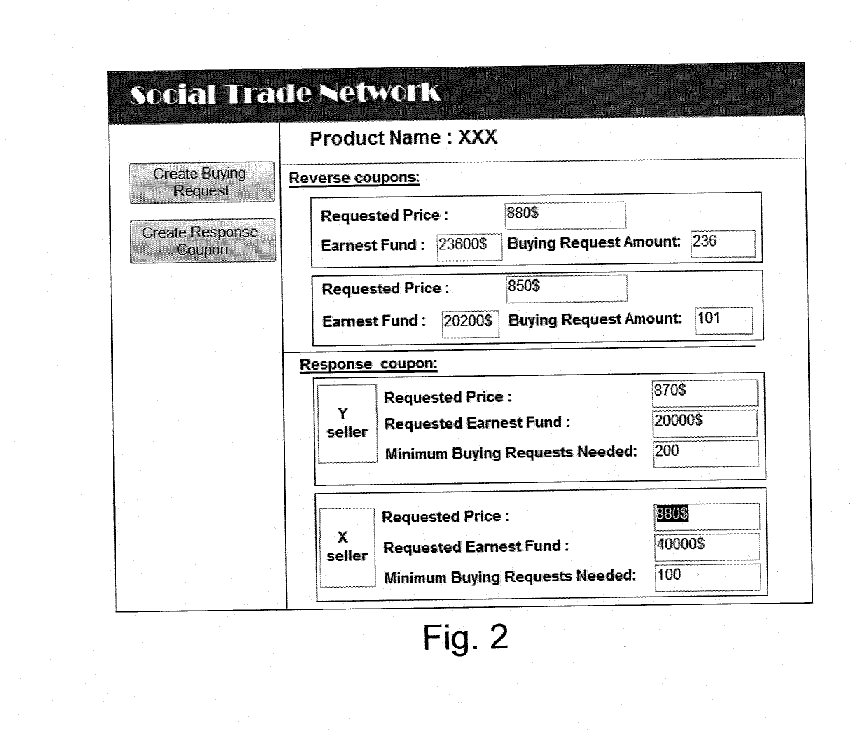

Referring now to FIG. 2, an example for buyers' and sellers' screen when they enter to the system is shown with respect to an embodiment of the present invention. In order to enable a negotiation between buyers and sellers in the system, buyers and sellers can see the current status of the reverse and response coupons when they enter to the system.

There is no order between the response and reverse coupons and sellers and buyers can enter their requests and offers freely all the time. The process of publishing response and reverse coupons (based on the “buying requests” of the buyers) occurs simultaneously like common in social networks.

Buyers can create a “buying request” that may be joined by the system to an existing “reverse coupon”. They can see the requested terms of transaction detailed in the various aggregated “reverse coupons” including the current buying requests' amount and “earnest fund”.

Also, the buyers and sellers can see the sellers' “response coupons” which were published in the site. The system updates the reverse and response coupons all the time according to the “buying requests” received from the buyers and by matching between the relevant reverse and response coupons.

If the “response coupon” is active the buyers can buy the coupon from the seller without the need to submit a “buying request”. If the “response coupon” isn't active because it lacks the minimum number of buyers requested or “earnest fund” needed, the buyer can create a “buying request” in order to enlarge the buyers' amount and “earnest fund”.

According to one embodiment of the present invention the seller can choose to submit his “response coupon” personally and secretly. Meaning the seller can request to send his coupon and to allow to buy his coupon only to the buyers who submitted a matched “buying request” aggregated in the “reverse coupon”. This tool can help the seller to keep their high price of selling product in the market, and to give a certain discount to a limited amount of buyers without the need to publish this price in publicity.

Sellers can see the buying terms of the buyers in an aggregated way shown in the “reverse coupons”. Afterwards, the sellers can decide to respond to the “reverse coupons” by submitting a matched “response coupon” which will force the buyers to buy one of the matched “response coupon” or to pay their “earnest fee”.

If there is already a matched “response coupon” for the “reverse coupon” the seller can decide to compete with this coupon by submitting a “response coupon” of his own with better buying terms. Afterwards, the buyers will decide which “response coupon” they prefer to buy from.

The seller can see all the other “response coupons” of the sellers including the name of the seller, the price offered, the “earnest fund” needed to activate the coupon, minimum number of buyers needed to activate the coupon and “expired date” of this coupon. If a “response coupon” is already active, then only the price, name of the seller and “expired date” will be shown, and the option of buying this coupon will be available for the buyers.

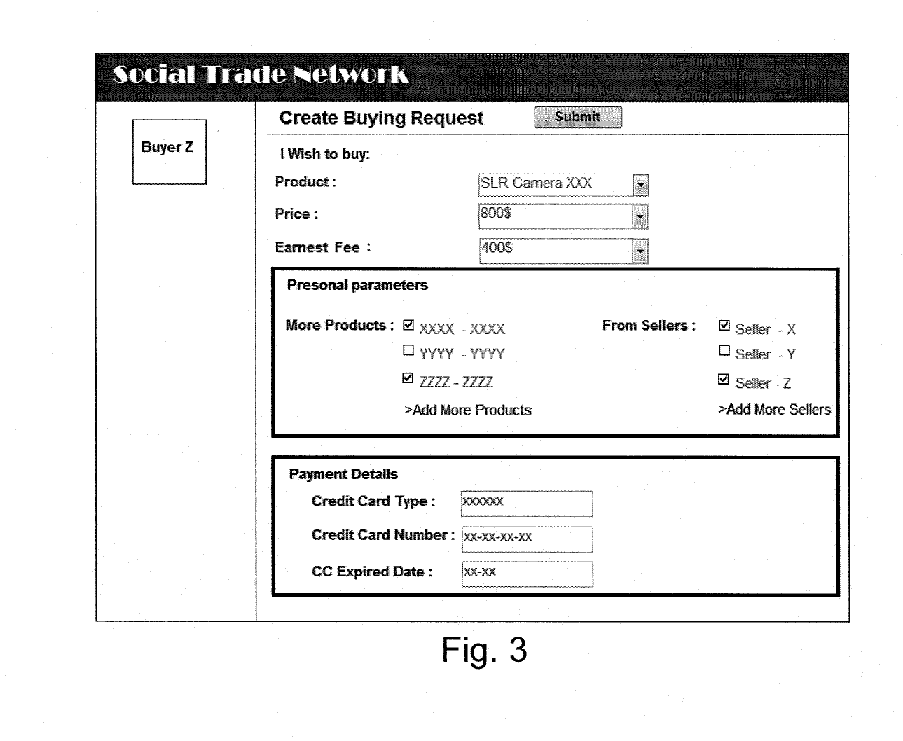

Referring now to FIG. 3, an example of a buyer's webpage for publishing a “reverse coupon” is shown, according to an embodiment of the present invention. Each buyer has a personal profile webpage like it is common in known social networks. Using the webpage, the buyer can create a “buying request” by inserting the product/service he is interested to buy plus the price of the product, his “earnest fee” level/amount and payment details.

Another embodiment is that the buyer can insert additional “personal parameters” like choosing several products which relate to the same category of products, the specific sellers he would like to receive “response coupons” from etc.

In order to publish a “buying request” the buyer needs to provide to the system his payment details (e.g., like his credit card) in order for the system to have the ability to charge the buyer for the “earnest fee”.

Also, by inserting a new “buying request”, the buyer may become part of a committed buying group if the system will find other similar “buying requests” that can be aggregated together in the same “reverse coupon” and therefore he can receive better “response coupons” as being part of that group.

FIG. 4, an example of a buyer's webpage for watching in real time the state of his “buying request” is shown, according to an embodiment of the present invention. The buyer can see in real time the state of his “buying request” by showing all the matched “response coupons”. The buyer can also watch the current status of the “reverse coupon” his “buying request” was aggregated to and other “reverse coupon” that exists in the system.

Also, if there are matched “response coupon” the buyer can see his “buying deadline”. The seller can limit the amount of products in his coupon and therefore the amount can be sold out before the “buying deadline” of the buyer ends. Therefore, the “earnest fee” will be charged from the buyer only if at the end of his “buying deadline”, at least one active matched “response coupon” will be left. The buyer will receive during this period an indication of matched “response coupons” (e.g., to his mail, by SMS, display it in his profile webpage, etc.).

The buyer can choose individually which “response coupon” he would like to buy from the list of matched “response coupons” shown. For example, he can choose according to his preferred seller or lower price. Also, the buyer can update his “buying request” only if there aren't any matched “response coupons”. Also, the buyer can dismiss his “buying request”—if there aren't any matched “response coupons”. If there are already matched “response coupons”, then the buyer will have to pay his “earnest payment”.

Referring now to FIG. 5, an example of a seller's webpage screen for publishing a “response coupon” is shown, according to an embodiment of the present invention. The seller can publish a “response coupon” according to his needs or by answering the buyers' “reverse coupons” with matched “response coupons”.

The seller inserts in his “response coupon” the price of the product offered and the product for sale. He can also define the “earnest fund” expected and minimum number of buyers. According to an embodiment of the present invention he can also add parameters like the maximum amount of products for sale and “expired date” of the coupon, etc.

Also, the seller can update his “response coupon” in order to receive more matched buyers shown in the “reverse coupons”. The seller can watch other sellers' “response coupons” and then to decide to update his “response coupon”. If the “response coupon” was matched to “reverse coupon” then the seller is committed to sell this coupon at the terms the buyers received and can't update it for the worth of the buyers.

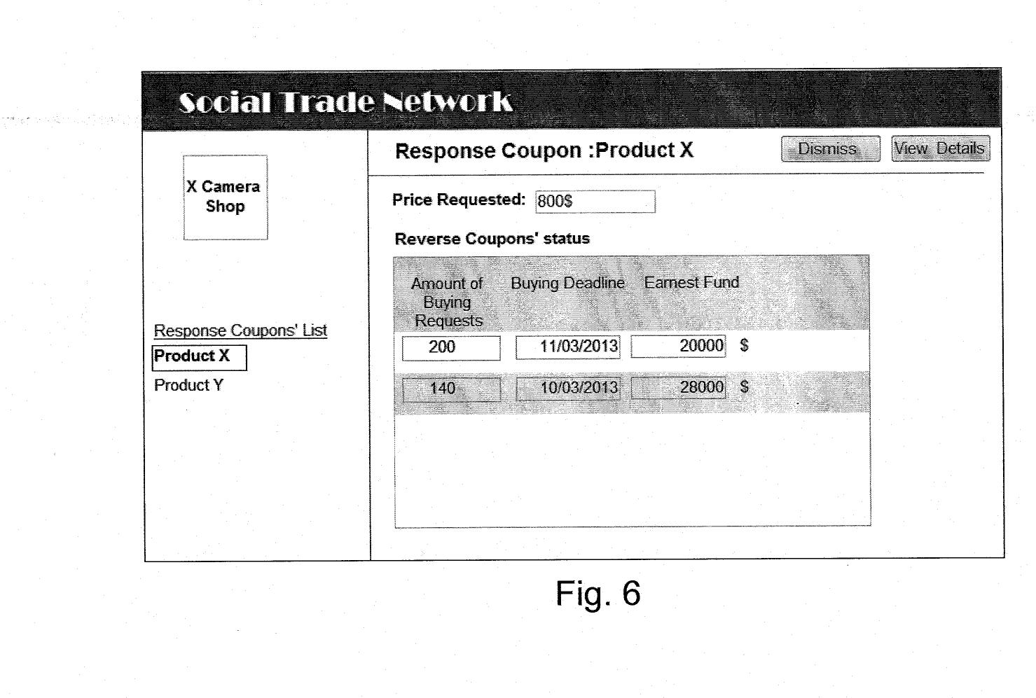

FIG. 6, an example of a seller's webpage for watching in real time the state of his “response coupons” is shown. The seller can watch in real time the current state of the “reverse coupons” for products/services he is interested to sell. The status of the “reverse coupons” include: The number of potential buyers for each product/service—this number is dynamic since each “reverse coupon” has different “buying deadlines” for different buyers. It can decrease since different buyers have different “buying deadlines” and seine of them may be over and it can increase since new “buying requests” can be aggregated to the existing “reverse coupons” all the time if they create “buying requests” that suits the current “reverse coupon” buying terms.

Also, the seller can see the price requested and “earnest payment” commitment shown in the “reverse coupon”. According to another embodiment of the present invention the seller can see the “personal parameters” of the buyers like the preferred sellers to buy from, etc. The seller will always see the aggregated “reverse coupons” in terms of quantity and quality of the buyers per product and won't need to deal with individual “buying requests” of individual buyers. The system aggregates all the time the relevant “buying requests” into united groups in the “reverse coupons”.

The seller can update his matched “response coupon” only for the benefit of the buyer, like decreasing the price of the product or decreasing the “earnest fund” expected. The seller can dismiss his “response coupon” any time and his “response coupon” will only stay relevant for the buyers who already received this coupon as a matched “response coupon” until the end of their “buying deadline”.

To conclude, the essence of this system is in its dynamic and open character. The computer system is neutral and doesn't intervene in the content of the buying requests and response coupons. It is only a technical tool in order to create united groups of buyers that can negotiate with the sellers. The system enables the buyers and sellers to insert their buying requests and response coupons freely, individually and simultaneously and then to update them on that basis in order to create the right matches between them.

The advantages of the method and system of the present invention comparing to the prior-art suggested auction system is in the ability of the buyers to submit their “buying requests” individually but to be treated as a group, since the system of the present invention can aggregate and combine all the similar “reverse coupons” which have specific quality and quantity properties. Also, for sellers the system will be able to show them in real time the potential committed “buying requests” of buyers which were aggregated to the various “reverse coupons” which contain “earnest fee” commitment.

Moreover, the advantages of the method comparing to the prior-art buying groups is in the ability of the buyers to create a “buying request” according to their needs, at the time they would like to buy this product, and to receive enough time to decide which coupon they would like to buy. Also, for the sellers it enables to track the committed buyers who are interested in their products and to offer them a suitable “response coupon” that answers their needs.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

In addition, while certain user inputs or gestures are described as being provided via phone key presses, data entry via a keyboard, or by clicking a computer mouse or button, optionally, user inputs can be provided using other techniques, such as by voice or otherwise. The example screen layouts, appearance, and terminology as depicted and described herein, are intended to be illustrative and exemplary, and in no way limit the scope of the invention as claimed.

1-23. (canceled)

24. A computer implemented method of conducting negotiation between a plurality of earnest buyers and sellers in a social trade network comprising:
obtaining a plurality of requests and offers from buyers and sellers respectively, wherein each request represents a wish to buy that includes products)/service(s) properties and terms of buying, and wherein each offer represents a wish to sell an item that includes product/service properties and terms of buying, wherein both requests and offers may include an earnest fee that represents the seriousness of a buyer or seller to complete a possible matched trade, and wherein each item is defined by its relevant properties and terms of buying;
creating a network by joining requests and offers based on similar properties of products)/service(s) and terms of buying and updating said network according to buyers'/sellers' changes, removals and additions of requests/offers accordingly, and accordingly notifying the buyers/sellers of said joined requests and offers about changes in one or more joining requests/offers for negotiating purpose; and
preforming a matching process between joined requests and offers with matched properties of products)/service(s) and terms of buying, while matched requests and offers are being obligated to matched offers and requests accordingly in terms of said earnest fee.

25. The method of claim 24, further comprising notifying the sellers about the earnest fees of the joined requests, thereby enabling the sellers to measure the potential of selling based on earnest fees, and updating the network according to the sellers' actions (changes, removals and additions to their offers).

26. The method of claim 24, further comprising notifying the sellers about the amount of the joined requests, thereby enabling the sellers to measure the potential of selling based on the said amount, and updating the network according to the sellers' actions.

27. The method of claim 24, further comprising notifying the sellers about the personal details of the buyers of the joined requests, in particular already requested items, obligation follow history, geographic location, other connected social data, thereby enabling the sellers to measure the potential of selling based of said details, and updating the network according to the sellers' actions.

28. The method of claim 24, further comprising notifying the buyers/sellers about joined offers/requests to their requests/offers accordingly in aggregated data.

29. The method of claim 24, further comprising assigning a deadline for each matched request/offer, and accordingly notifying the buyers/sellers of matched request/offer who did not complete the trade of said matched offer/request until the end of their deadline about their obligation to do so in terms of earnest fee.

30. The method of claim 24, wherein each request may include quantity that represents the amount of items the buyer interested in wherein the earnest fee represents the seriousness of the buyer to complete a possible matched trade for each item.

31. The method of claim 24, wherein each offer may include minimum number of matched joined requests in order to activate the offer.

32. The method of claim 24, further comprising updating the earnest fee amount to zero for matched request only after being first joined to matched offer.

33. A computer-readable medium that stores instructions executable by one or more processing devices to perform a method of conducting negotiation between a plurality of earnest buyers and sellers in a social trade network comprising:
an instruction for obtaining a plurality of requests and offers from buyers and sellers respectively, wherein each request represents a wish to buy that includes product(s)/service(s) properties and terms of buying, and wherein each offer represents a wish to sell an item that includes product/service properties and terms of buying, wherein both requests and offers may include an earnest fee that represents the seriousness of a buyer or seller to complete a possible matched trade, and wherein each item is defined by its relevant properties and terms of buying;
an instruction for creating a network by joining requests and offers based on similar properties of product(s)/service(s) and terms of buying, updating said network according to buyers'/sellers' changes, removals and additions of requests/offers accordingly, and accordingly notifying the buyers/sellers of said joined requests and offers about changes in one or more joining requests/offers for negotiating purpose; and
an instruction for preforming a matching process between joined requests and offers with matched properties of product(s)/service(s) and terms of buying, while matched requests and offers are being obligated to matched offers and requests accordingly in terms of said earnest fee.
